(19) United States
(12) Patent Application Publication
(10) Pub. No.: US 2014/0127969 A1
(43) Pub. Date: May 8, 2014

(54) MAN-MADE BEEHIVE

(71) Applicants: Paul Mullins, Hoodsport, WA (US); Linda Mullins, Hoodsport, WA (US)

(72) Inventors: Paul Mullins, Hoodsport, WA (US); Linda Mullins, Hoodsport, WA (US)

(21) Appl. No.: 13/671,466

(22) Filed: Nov. 7, 2012

(51) Int. Cl. A01K 49/00; A01K 47/06; A01K 59/00; A01K 53/00

(52) U.S. Cl. 449/7

(57) ABSTRACT

The present invention is a man-made beehive that allows a plurality of bees to store more of a plurality of honey than a traditional beehive that includes a natural cedar wood general rectangular shape two queen hive, a plurality of brood boxes removably held within the two queen hive, the broad boxes house a plurality of eggs, larvae and pupae from the bees utilized by the man-made beehive and a plurality of screened bottom boards positioned in the bottom portion of the two queen hive. The man-made beehive also includes a telescoping cover positioned on the top portion of the two queen hive to protect the man-made beehive and a queen excluder that is positioned between a pair of the broad boxes.

### TECHNICAL FIELD & BACKGROUND

Beehives are commonly maintained to produce honey and/or to assist in the pollination of local crops. Currently there is a need for a better insulated, longer lasting man-made beehive and design.

The present invention generally relates to a beehive. More specifically, the invention is a man-made beehive.

It is an object of the invention to provide a man-made beehive that utilizes natural cedar wood and a plurality of air flow vents.

It is an object of the invention to provide a man-made beehive that has relatively better insulation and is relatively more durable than a traditional beehive.

What is really needed is a man-made beehive that utilizes natural cedar wood and a plurality of air flow vents that has relatively better insulation and is relatively more durable than a traditional beehive.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a man-made beehive, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

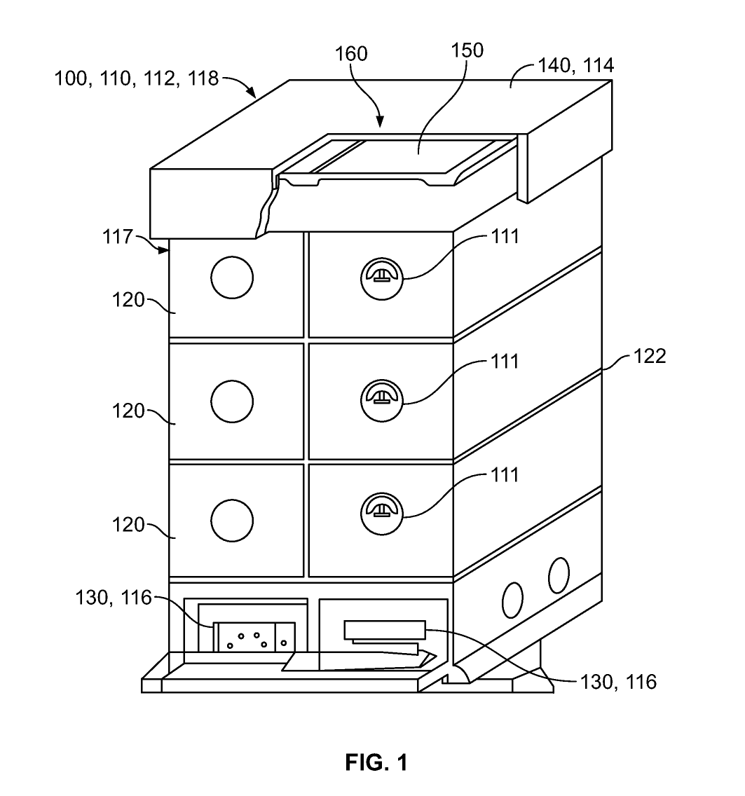

FIG. 1 illustrates a front view of a man-made beehive 100, according to an embodiment of the present invention.

The man-made beehive 100 includes a two queen hive 110, a plurality of brood boxes 120, a plurality of screened bottom boards 130 and a telescoping cover 140. The man-made beehive 100 allows a plurality of bees to store more of a plurality of honey than a traditional beehive. The two queen hive 110 has a general rectangular shape 112, a top portion 114, a bottom portion 116, a front 117 and includes a pair of queen hives 118 and is man-made of natural cedar wood. The natural cedar wood is approximately 1 inch in thickness but can be other suitable thicknesses as well and provides relatively more durability and insulation than traditional man-made beehives. The natural cedar wood is provided with a plurality of air flow vents 111 disposed on the two queen hive 110 to provide added ventilation to the two queen hive 110.

The two queen hive 110 can also accommodate any suitable number of queens such as a one queen beehive, a three queen beehive and any suitable number of queen beehives. The broad boxes 120 include 6 broad boxes 120 removably held within the two queen hive 110 but can include any suitable number of broad boxes. The broad boxes 120 house a plurality of eggs, larvae and pupae from a plurality of bees utilized by the man-made beehive 100. There is also a queen excluder 122 that can be positioned between a pair of the broad boxes 120. The screened bottom boards 130 are positioned in the bottom portion 116 of the two queen hive 110. The screened bottom boards 130 provide well-suited ventilation and prevent the bees from assembling in the front 117 of the two queen hive 110. The telescoping cover 140 is positioned on the top portion 114 of the two queen hive 110 to protect the man-made beehive 100. The man-made beehive 100 includes approximately two 13 frame honey supers 150 although the man-made beehive 100 can includes any suitable number of frame honey supers. The man-made beehive 100 also includes a top feeder 160 that is utilized at the top portion 114 of the two queen hive 110.

The man-made beehive is made from approximate 1 inch natural cedar wood with a plurality of air flow vents. The man-made beehive is a two queen hive with three brood boxes per queen which house the eggs, larvae and pupae. In order to provide well-suited ventilation and keep a relatively large number of bees from assembling in the front of the man-made beehive, the man-made beehive is equipped with a plurality of screened bottom boards. Among those who will find the man-made beehive useful are beekeepers and bee supply companies. The man-made beehive features a man-made hive made of approximately two 13-frame honey supers with a top feeder made of approximately 1 inch natural cedar wood. The man-made beehive is designed with a telescoping cover to keep the weather and environmental elements out of the man-made beehive.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A man-made beehive that allows a plurality of bees to store more of a plurality of honey than a traditional beehive, comprises:
a two queen hive that includes a top portion, a bottom portion, a front and a pair of queen hives;
a plurality of brood boxes removably held within the two queen hive, the broad boxes house a plurality of eggs, larvae and pupae from the bees utilized by the man-made beehive;
a plurality of screened bottom boards positioned in the bottom portion of the two queen hive; and
a telescoping cover positioned on the top portion of the two queen hive to protect the man-made beehive.

2. The man-made beehive according to claim 1, wherein the two queen hive has a general rectangular shape.

3. The man-made beehive according to claim 1, wherein the two queen hive is made of natural cedar wood.

4. The man-made beehive according to claim 3, wherein the natural cedar wood is approximately 1 inch in thickness.

5. The man-made beehive according to claim 3, wherein the natural cedar wood provides more durability than the traditional man-made beehive.

6. The man-made beehive according to claim 3, wherein the natural cedar wood provides more insulation than the traditional man-made beehive.

7. The man-made beehive according to claim 1, wherein the brood boxes includes a queen excluder that is positioned between a pair of the broad boxes.

8. The man-made beehive according to claim 1, wherein the screened bottom boards provide well-suited ventilation to the man-made beehive.

9. The man-made beehive according to claim 1, wherein the screened bottom boards prevent the bees from assembling in the front of the two queen hive.

10. The man-made beehive according to claim 1, wherein the man-made beehive includes approximately two 13 frame honey supers.

11. The man-made beehive according to claim 1, wherein the man-made beehive includes a top feeder.

12. A man-made beehive that allows a plurality of bees to store more of a plurality of honey than a traditional beehive, comprises:
a natural cedar wood general rectangular shape two queen hive that includes a top portion, a bottom portion, a front and a pair of queen hives;
a plurality of brood boxes removably held within the two queen hive, the broad boxes house a plurality of eggs, larvae and pupae from the bees utilized by the man-made beehive;
a plurality of screened bottom boards positioned in the bottom portion of the two queen hive;
a telescoping cover positioned on the top portion of the two queen hive to protect the man-made beehive; and
a queen excluder that is positioned between a pair of the broad boxes.

13. The man-made beehive according to claim 12, wherein the natural cedar wood is approximately 1 inch in thickness.

14. The man-made beehive according to claim 12, wherein the natural cedar wood provides more durability than the traditional man-made beehive.

15. The man-made beehive according to claim 12, wherein the natural cedar wood provides more insulation than the traditional man-made beehive.

16. The man-made beehive according to claim 12, wherein the natural cedar wood is provided with a plurality of air flow vents disposed on the two queen hive, the air flow vents provide added ventilation to the two queen hive.

17. The man-made beehive according to claim 12, wherein the screened bottom boards provide well-suited ventilation to the man-made beehive.

18. The man-made beehive according to claim 12, wherein the screened bottom boards prevent the bees from assembling in the front of the two queen hive.

19. The man-made beehive according to claim 12, wherein the man-made beehive includes approximately two 13 frame honey supers.

20. The man-made beehive according to claim 12, wherein the man-made beehive includes a top feeder.
